(19) United States
(12) Patent Application Publication
(10) Pub. No.: US 2026/0147869 A1
(43) Pub. Date: May 28, 2026

(54) ANTI-REPLAY FEATURE FOR SYSTEM-ON-A-CHIP POWER DOWN AND MEMORY SELF-REFRESH

(71) Applicant: QUALCOMM Incorporated, San Diego, CA (US)

(72) Inventors: Pranav AGRAWAL, Bengaluru (IN); Gur Prasad SRIVASTAVA, Bengaluru (IN); Priyanka DOSI, San Diego, CA (US); Gaurav SINGHAL, Hyderabad (IN); Luca FIORE, Cork (IE); Dhruv GOEL, Delhi (IN); Vinay VISHAKANTA MURTHY, Mysore (IN); Marcel SELHORST, Zeuthen (DE); Joona Verneri KANNISTO, Salo (FI)

(21) Appl. No.: 18/960,655

(22) Filed: Nov. 26, 2024

(51) Int. Cl. G06F 21/44; G06F 1/3228; G06F 21/57

(52) U.S. Cl. CPC G06F 21/44; G06F 1/3228; G06F 21/572; G06F 2221/034

(57) ABSTRACT

Aspects of the present disclosure provide techniques for enabling an anti-replay feature on systems that power down a system-on-a-chip (SoC). The techniques generally include utilizing anti-replay counters (ARCs) to authenticate data stored in a first region of memory by generating tags for segments of the data using a hash algorithm under a first hardware configuration; entering a low power state in which the memory is placed in a self-refresh state; upon exiting the low power state initiating a boot procedure, rebuilding the ARCs and tags by reading data back from and writing data back to the first region of the memory under a second hardware configuration; and proceeding with the boot procedure and restoring the first hardware configuration after the rebuilding if one or more conditions are met.

### BACKGROUND

### Field of the Disclosure

Aspects of the present disclosure relate generally to security features and, more particularly, to an anti-replay feature on systems that power down a system-on-a-chip (SoC).

### Description of Related Art

The term “system-on-a-chip” (SoC) generally refers to an integrated electronic device comprising one or more integrated circuit (IC) dies (e.g., chiplets), which combines multiple electronic components (e.g., processors and/or memory) on a single substrate or in a single package. A single SoC may contain circuitry for digital, analog, mixed-signal, and/or radio-frequency functions. A single SoC may also include any number of general purpose and/or specialized processors, memory blocks, and other resources. An SoC may also include software for controlling the integrated resources and processors, as well as for controlling peripheral devices.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide the advantages described herein.

Certain aspects of the present disclosure provide a method generally including utilizing anti-replay counters (ARCs) to authenticate data stored in a first region of memory by generating tags for segments of the data using a hash algorithm under a first hardware configuration; entering a low power state in which the memory is placed in a self-refresh state; upon exiting the low power state initiating a boot procedure, rebuilding the ARCs and tags by reading data back from and writing data back to the first region of the memory under a second hardware configuration; and proceeding with the boot procedure and restoring the first hardware configuration after the rebuilding if one or more conditions are met.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be by reference to aspects, some of which are illustrated in the appended drawings. It is to be noted, however, that the appended drawings illustrate only certain aspects of this disclosure and are therefore not to be considered limiting of its scope, for the description may admit to other equally effective aspects.

FIG. 1 is a block diagram of example components and interconnections in a system-on-a-chip (SoC), in which aspects of the present disclosure may be practiced.

FIG. 2 illustrates an example anti-replay counter (ARC) mechanism.

FIG. 3 illustrates an example of trust zone (TZ) data flow.

FIG. 4 illustrates an example of operations during a power down to implement an anti-replay feature, in accordance with aspects of the present disclosure.

FIG. 5 illustrates an example of operations during a boot sequence to implement an anti-replay feature, in accordance with aspects of the present disclosure.

FIG. 6 illustrates an example call flow diagram for an anti-replay feature, in accordance with aspects of the present disclosure.

FIG. 7 illustrates a potential replay attack path that may be mitigated in accordance with aspects of the present disclosure.

FIG. 8 depicts an example method for an anti-replay feature, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate generally to security features and, more particularly, to an anti-replay feature on systems that power down a system-on-a-chip (SoC).

In some SoC based systems, a security mechanism utilizes a concept of two worlds: a secure world and a non-secure world. The separation of secure and non-secure is typically enforced by hardware and protects data and code by preventing non-secure software from directly accessing secure resources. For this reason, the secure resources may be referred to as TrustZone (TZ) resources.

For example, sensitive data may be located either in internal memory or in an encrypted, integrity-protected memory region of memory external to the SoC (such as double data rate-DDR memory) that may be referred to as pseudo internal memory (PIMEM). To maintain the confidentiality and integrity of TZ data, memory protection hardware (e.g., which may be referred to as PIMEM hardware) may be implemented to provide encryption and authentication (CIA) services to any writes going to DDR from the TZ environment.

Data exchanged between an SoC and external memory may be subject to replay attacks. A replay attack generally refers to a type of attack that involves an attacker intercepting and retransmitting data that was exchanged between two entities. The attacker attempts to appear as the valid sender of the message, hoping the receiver will consider the data authentic.

One approach to protect against replay attacks is via a mechanism referred to as a freshness feature that generates hash codes or tags for data segments based on counters, referred to as Anti Replay Counters (ARCs). To maintain protection against replay attacks on the counters themselves, certain root level global counters must be stored in the SOC and never written to DDR, to prevent their exposure.

Certain low power features may pose a challenge to this approach, however. For example, in some low power states the SOC may be shut down, while external memory (e.g., DDR) is kept in a self-refresh to preserve the data. This approach helps achieve faster boot times, but the root level ARC counters used for the freshness feature is lost as the SOC is powered down. Additional hardware to preserve root level counters may be avoided, for example, to save silicon area and leakage power. With the root level ARC counters not preserved, however, it may not be possible to implement the anti-replay feature across power down and boot cycles.

Aspects of the present disclosure help support an anti-replay feature on systems that power down the SoC. According to certain aspects, upon exiting a low power state, ARCs and tags may be rebuilt by reading data back from and writing data back to the PIMEM region of the memory. In some cases, the memory protection hardware may be placed in a certain state during the rebuilding (e.g., to prevent spurious authentication errors). In some cases, to protect against data modification attacks, while going into the low power state, the PIMEM region may be read, and an authentication code may be generated and stored in another region of memory. During reboot, while reading the PIMEM for the ARC rebuilding, the authentication code may be generated and compared against the previous stored value. If there is any modification of the data during the low power state, then this comparison will fail and an error may be flagged (e.g., and a quick-boot procedure aborted).

By supporting an anti-replay feature on systems that power down the SoC, aspects of the present disclosure may allow for power savings of low power (e.g., deep sleep) states with fast reboot procedures, while still supporting anti-replay features.

### Example System-on-a-Chip

As used herein, the term “system-on-a-chip” (SoC) generally refers to an integrated electronic device comprising one or more integrated circuit (IC) dies (e.g., chiplets), which combines multiple electronic components (e.g., processors and/or memory) on a single substrate or in a single package. A single SoC may contain circuitry for digital, analog, mixed-signal, and/or radio-frequency functions. A single SoC may also include any number of general purpose and/or specialized processors (digital signal processors, modem processors, video processors, etc.), memory blocks (e.g., ROM, RAM, DRAM, flash, etc.), and resources (e.g., timers, voltage regulators, oscillators, etc.). An SoC may also include software for controlling the integrated resources and processors, as well as for controlling peripheral devices.

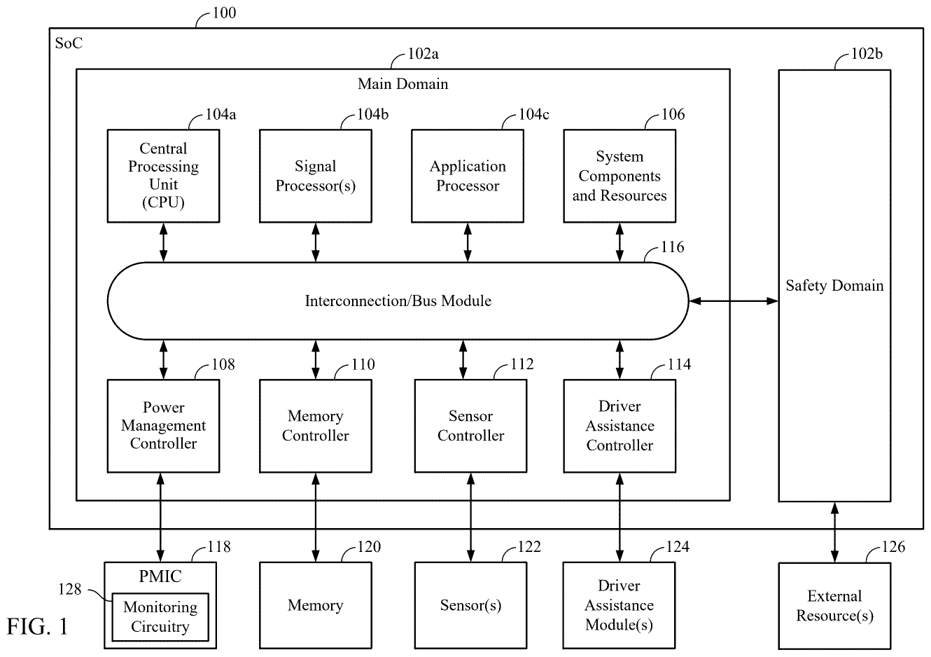

FIG. 1 is a block diagram of example components and interconnections in a SoC 100 suitable for implementing various aspects of the present disclosure. The SoC 100 may include multiple processing domains having, for example, at least one main domain 102a and at least one safety domain 102b (also referred to as a “safety island (SAIL)”). In the case of multiple main (or safety) domains, the main (or safety) domains may be similar to one another. For ease of description and illustration, the remainder of the disclosure may refer to a main domain 102a and a safety domain 102b, but the reader is to understand that there may be more than one main domain and/or more than one safety domain.

The main domain 102a may be configured to support (or be capable of performing) vehicle operations (e.g., driver assistance and/or automated driving operations, features, etc.) up to a specific automotive safety integrity level (ASIL), and the safety domain 102b may be configured to support (or be capable of performing) vehicle operations up to a lower, the same, or a higher ASIL than the main domain 102a. For example, the main domain 102a may be configured to support (or be capable of performing) vehicle operations up to an ASIL B, and the safety domain 102b may be configured to support vehicle operations up to an ASIL D. In some cases, the main domain 102a may be configured to support (or be capable of performing) vehicle operations up to an ASIL A, B, C, or D, and the safety domain 102b may be configured to support vehicle operations up to a different ASIL than the main domain 102a. In certain cases, the main domain 102a and the safety domain 102b may be configured to support (or be capable of performing) vehicle operations at the same ASIL (e.g., ASIL D). The main domain 102a and the safety domain 102b may be configured to support (or be capable of performing) vehicle operations at different ASILs.

The ASILs may be defined in a specific safety standard, such as ISO 26262. For example, the ASILs may provide a risk classification scheme for certain electrical and electronic systems of road vehicles. ISO 26262 provides four ASILs including ASIL A, ASIL B, ASIL C, and ASIL D. ASIL D is the highest classification and corresponds to the highest level of safety measures for avoiding an unreasonable residual risk, and ASIL A is the lowest classification and corresponds to the lowest level of safety measures.

In certain aspects, the SoC 100 may be included in a computing device (e.g., an ECU) in a vehicle control system. The SoC 100 may control any of the systems described herein with respect FIG. 1. For example, the SoC 100 may be configured to control an ADAS/AD system, such as the driver assistance controller 114 and/or automated driving control system described herein with respect to FIG. 1. In certain aspects, the SoC 100 may be in communication with other ECU(s) in a vehicle control system, and the SoC 100 and/or a PMIC 118 may report errors associated with the SoC 100 to the other ECU(s). For example, the main domain 102a may control the environmental system, the infotainment system, and driver assistance features up to a certain ASIL, and the safety domain 102b may control driver assistance features up to a certain ASIL, which may typically be higher than the main domain 102a.

The main domain 102a and/or safety domain 102b may include a number of heterogeneous processors 104 a-c (collectively referred to herein as “processors 104”), such as a central processing unit (CPU) 104a, signal processor(s) 104b (e.g., a digital signal processor, an image signal processor, a neural network signal processor, etc.), and/or an application processor 104c. Each processor 104 may include one or more cores, and each processor/core may perform operations independent of the other processors/cores. Each processor 104 may be part of a subsystem (not shown) including one or more processors, caches, etc. configured to handle certain types of tasks or computations. It should be noted that the main domain 102a and/or safety domain 102b may include additional processors (not shown) or may include fewer processors (not shown). The main domain 102a and/or safety domain 102b may include other processors (e.g., a graphics processing unit (GPU), a vision processing unit, etc.) in addition to or instead of those illustrated.

The main domain 102a and/or safety domain 102b may include system components and resources 106 for performing certain specialized operations, such as analog-to-digital conversions and/or wireless data transmissions. The system components and resources 106 may include components such as voltage regulators, oscillators, phase-locked loops (PLLs), modems, peripheral bridges, data controllers, system controllers, access ports, timers, and other similar components used to support the processors and software clients running on the SoC 100. The system components and resources 106 may include circuitry for interfacing with peripheral devices, such as cameras, electronic displays, wireless communication devices, external memory chips, etc.

The main domain 102a and/or safety domain 102b may further include a power management controller 108, a memory controller 110 (e.g., a dynamic random access memory (DRAM) memory controller and/or a non-volatile memory controller), a sensor controller 112, and/or a driver assistance controller 114. The main domain 102a and/or safety domain 102b may also include an input/output (IO) module (not shown) for communicating with resources external to the SoC, such as a clock and a voltage regulator, each of which may be shared by two or more of the internal SoC components. The IO module may include a general purpose IO (GPIO) interface, for example. In certain aspects, each of the main domain 102a and the safety domain 102b may have a separate clock and power supply to facilitate independent operability.

The processors 104 of the main domain 102a may be interconnected to the system components and resources 106, the power management controller 108, the memory controller 110, the sensor controller 112, the driver assistance controller 114, other system components, and/or the safety domain 102b via an interconnection/bus module 116, which may include an array of reconfigurable logic gates and/or implement a bus architecture (e.g., CoreConnect, advanced microcontroller bus architecture (AMBA), etc.). Communications may be provided by advanced interconnects, such as high performance networks-on-chip (NoCs).

The interconnection/bus module 116 may include or provide a bus mastering system configured to grant SoC components (e.g., processors, peripherals, etc.) exclusive control of the bus (e.g., to transfer data) for a set duration, number of operations, number of bytes, etc. In certain aspects, the interconnection/bus module 116 may include a direct memory access (DMA) controller (not shown) that enables components connected to the interconnection/bus module 116 to operate as a master component and initiate memory transactions. The interconnection/bus module 116 may implement an arbitration scheme to prevent multiple master components from attempting to drive the bus simultaneously.

The power management controller 108 may manage the power supplied to the main domain 102a from a PMIC 118, which may be representative of one or more PMIC(s). In some cases, the power management controller 108 may report errors associated with the main domain 102a and/or safety domain 102b to the PMIC 118, as further described herein. The power management and error monitoring control may be separate and independent between the main domain 102a and the safety domain 102b.

The memory controller 110 may be a specialized hardware module configured to manage the flow of data to and from a memory 120. The memory controller 110 may include logic for interfacing with the memory 120, such as selecting a row and column in a cell array of the memory 120 corresponding to a memory location, reading or writing data to the memory location, etc. The memory 120 may be an on-chip component (e.g., on the substrate, die, integrated chip, etc.) of the SoC 100, or alternatively (as shown) an off-chip component.

The sensor controller 112 may manage the sensor data received from various sensors 122. The sensor controller 112 may include circuitry for interfacing with the sensors 122. For example, the sensor controller 112 may receive sensor data from a tire pressure monitoring system and/or a radar sensor used for adaptive cruise control.

The driver assistance controller 114 may control certain driver assistance functions via a driver assistance module 124 (e.g., one or more actuators, relays, switches, etc.). For example, the driver assistance controller 114 may control the adaptive cruise control by controlling actuators coupled to the engine and/or braking system. In some cases, the driver assistance controller 114 may perform automated steering by controlling actuators attached to the steering system. It will be appreciated that the driver assistance controller 114 is merely an example, and the main domain 102a and/or the safety domain 102b may include a controller that interfaces with automated driving components in addition to or instead of the driver assistance controller 114.

The SoC 100 may also include additional hardware and/or software components that are suitable for collecting sensor data from sensors, including speakers, user interface elements (e.g., input buttons, touch screen display, etc.), microphone arrays, sensors for monitoring physical conditions (e.g., location, direction, motion, orientation, vibration, pressure, temperature, etc.), cameras, compasses, GPS receivers, communications circuitry (e.g., Bluetooth®, wireless local area network (WLAN), Long Term Evolution (LTE), Fifth Generation New Radio (5G NR), etc.), and other well-known components (e.g., accelerometer, etc.) of modern electronic devices.

Each of the processing domains may operate independently of the other domains. In some cases, each of the processing domains may be coupled to separate and independent external resources, such as a PMIC, memory, sensor(s), and driver assistance module(s). A particular external resource may be designed in accordance with an ASIL corresponding to the particular ASIL associated with the main domain 102a and/or the safety domain 102b to which the external resource is coupled. For example, the PMIC 118 may have the same ASIL as the main domain 102a, and the PMIC that provides power to the safety domain 102b may have the same ASIL as the safety domain 102b. The safety domain 102b may include the same or different processing resources and components as the main domain 102a as described herein with respect to the main domain 102a. For example, the safety domain 102b may include the processors 104, the system components and resources 106, the power management controller 108, the memory controller 110, the sensor controller 112, and the driver assistance controller 114. The safety domain 102b may be coupled to certain external resource(s) 126, which may be representative of a PMIC, memory, sensors, and/or driver assistance module, for example, as described herein with respect to the main domain 102a.

In addition to the SoC 100 discussed above, various aspects may be implemented in a wide variety of computing systems, which may include a single processor, multiple processors, multicore processors, or any combination thereof. Various aspects described herein may also be implemented in systems that employ more than one SoC. For example, a SoC-based ECU may include multiple SoCs (e.g., SoCs 100) configured to monitor the safety of a vehicle control system (e.g., vehicle control system 102). In these examples, each of the multiple SoC(s) may include different numbers of main domains and/or safety domains.

### Anti-Replay Feature for Systems Supporting SoC Power Down and Memory Self-Refresh

Aspects of the present disclosure relate generally to security features and, more particularly, to an anti-replay feature on systems that power down a system-on-a-chip (SoC).

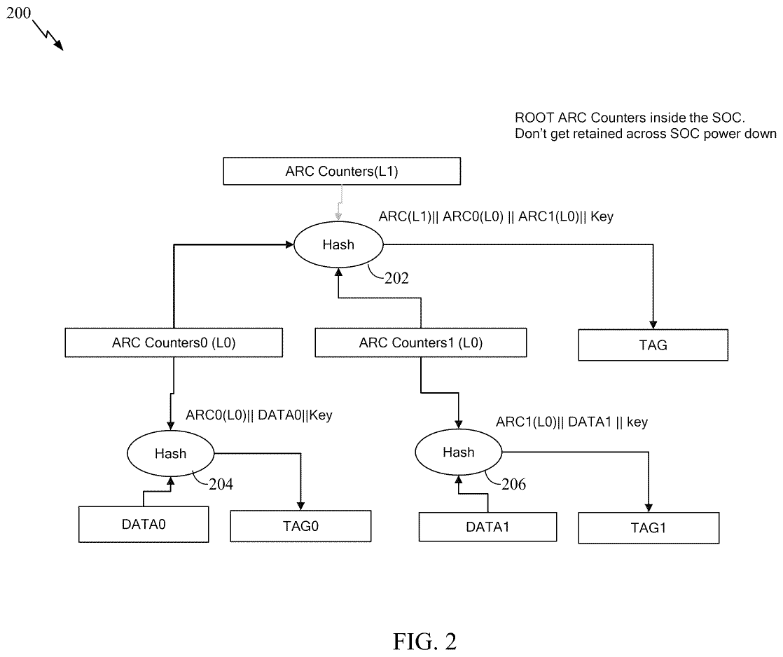

As noted above, one approach to protect against replay attacks is via a mechanism referred to as a freshness feature, as illustrated in diagram 200 of FIG. 2. The data structures shown in FIG. 2, ARC counters and metadata (e.g., tags) may be referred to as an ARC tree.

As illustrated at 204 and 206 in diagram 200 of FIG. 2, according to this mechanism, hash codes or tags (e.g., TAG0 and TAG1) for data segments (e.g., DATA0 and DATA1) may be generated based on counters (e.g., ARC Counter0 and ARC Counter1) and an authentication key. As illustrated at 202, a hash tag may also be generated based on the ARC Counters.

In general, every time a data segment (e.g., DATA0) is modified and written to the PIMEM region of memory, ARCs (e.g., ARC0(L0), ARC(L1)) get incremented and a tag (e.g., TAG0) gets updated based on the new values. When the data segments are read, the corresponding TAGs are also fetched. PIMEM hardware will then recompute the TAG based on the data and current values of the ARCs, and compares the recomputed TAG values against the stored values.

As noted above, the PIMEM region generally refers to the region where encryption, authentication, replay features are enabled. Access to this region is via hardware that provides these services, referred to as PIMEM hardware.

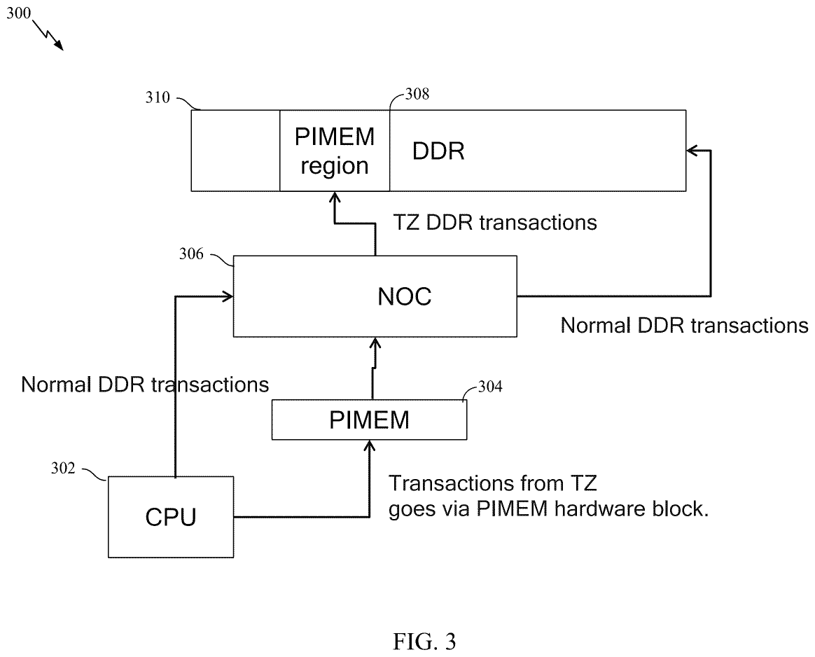

FIG. 3 shows an overview of PIMEM data flow between a CPU 302 and a PIMEM region 308 of a DDR 310, via PIMEM hardware block 304. As illustrated, normal (e.g., non-TZ) data transactions may be stored (e.g., routed via a network on a chip NOC 306) to a normal (e.g., non PIMEM) region of DDR 310. Transactions from the TZ, on the other hand, may go through a PIMEM hardware block 304 and stored in PIMEM region 308.

A replay attack may be detected if, for example, older data is used and replaced, because this hash TAG check will fail as the PIMEM will compute the hash TAG with the latest counter value, while the older copy of the data will have a different hash TAG based on a previous value of the ARC counter.

Referring again to FIG. 2, to maintain protection against replay attacks, certain root level global counters must be stored in the SOC and never written to DDR, to prevent their exposure.

As noted above, however, across low power (e.g., deep sleep or DS) and boot (e.g., quick boot QB) cycles after the SOC is shut down and wakes up, DDR data is preserved, while the SOC internal memories are lost, including the PIMEM hardware internal memory that stored the root counters. As a result, while performing the data read, the hash TAG checks will fail, as the PIMEM hardware will try to compute hash using the reset value of the counter while the TAGs in the DDR were computed with the pre low power mode (pre-LPM) counter values.

Aspects of the present disclosure, however, help support an anti-replay feature across low power mode (LPM) cycles.

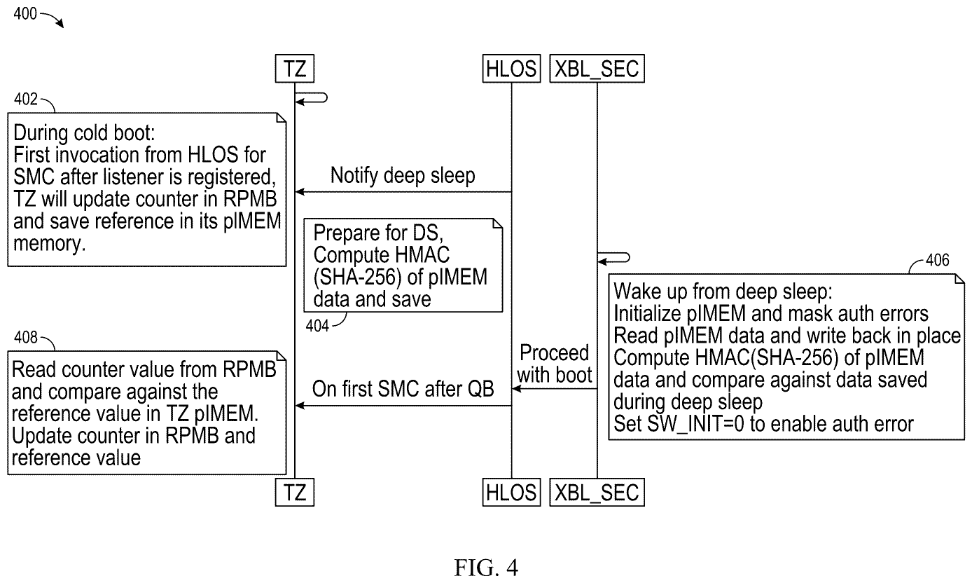

Diagram 400 of FIG. 4 shows various operations that may be performed in the various processing paths of an LPM cycle. The diagram shows interactions between TZ, a high-level operating system (HLOS), and a boot loader (e.g., a secure extensible boot loader (XBL_SEC) that coordinates the loading of a trusted execution environment (TEE)).

As noted above, the processing paths include DS and QB. In DS, the SoC is turned off to save power, while DDR is kept powered ON (e.g., at least with self-refresh) to retain the DDR content. In QB, the SOC resumes from power down. It may be referred to as quick, because the SOC does not have to recopy the data/images from storage, as the DDR data is retained.

As illustrated at 402 of FIG. 4, after cold boot (e.g., an initial power up), TZ may perform multiple operations on the data from the (CIA Protected DDR) PIMEM region contents. Because of this, the ARC counters will be in a particular (initialized) state and stored in global variable(s) (e.g., in TZ PIMEM memory). In some cases, a counter value may also be updated and stored in a replay protected memory block (RPMB).

As illustrated at 404, upon receiving a notification (e.g., from a HLOS), the TZ may take various actions to prepare for DS. For example, these actions may be designed to retain the states of the ARC counters that are not typically retained across the LPM cycle.

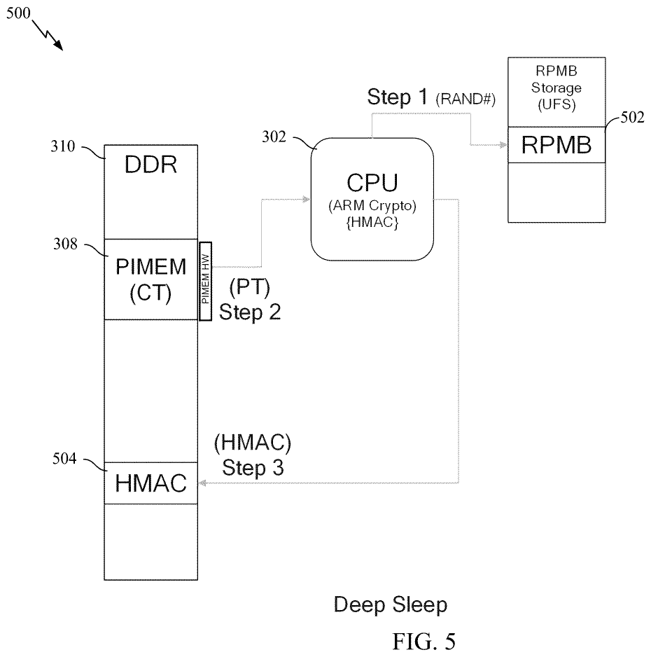

Diagram 500 of FIG. 5 illustrates examples of actions taken to prepare for DS. As illustrated, as a first step (Step 1), a freshness seed (e.g., updated/global counter) may be generated and stored in a location 502 of RPMB storage. This global counter may be used to prevent PIMEM region replay attacks during DS/QB cycles that use previous versions of the counter (that would not match the current counter stored in RPMB).

In some cases, a unique device key may also be derived, wrapped (e.g., encrypted with another key) and saved to memory. This new key may help further defend against replay attacks.

In a second step (Step 2), the PIMEM region 308 of DDR 310 may be read (e.g., location by location), in order to generate a hash code such as a Hash Message Authentication Code (HMAC) 504. The hash code (HMAC 504) generated based on the PIMEM data may then be stored in a normal (e.g., non-PIMEM) region of DDR, at a third step (Step 3).

Deep sleep may then be entered for some amount of time. Referring again to FIG. 4, at 406, various actions may be taken upon waking up from deep sleep.

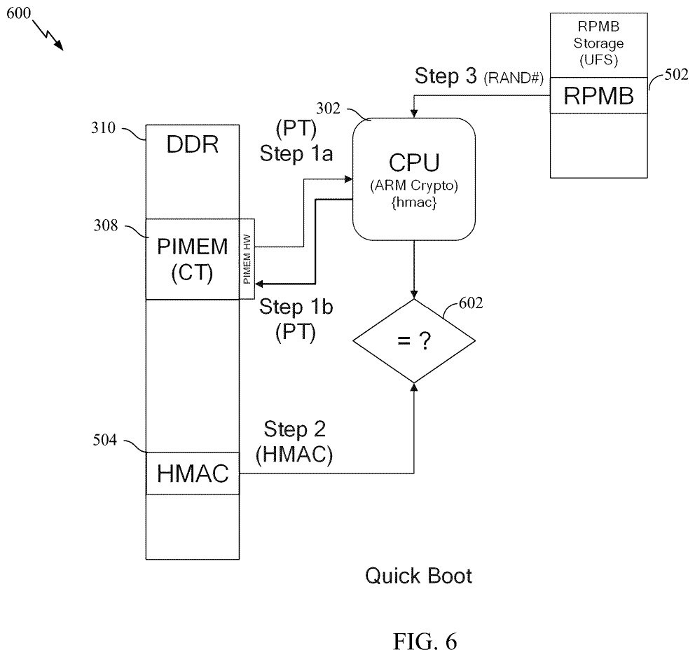

Diagram 600 of FIG. 6 illustrates examples of such actions taken upon waking up from deep sleep (e.g., as part of/in preparation for a quick boot).

In a first step, the CPU may read from (Step 1a) and write to (Step 1b) the PIMEM region 308 of the DDR 310, in order to rebuild the ARC counters, and initialize the PIMEM. In some cases, the PIMEM may be read and written back in small chunks (e.g., portions).

In the event a unique key was derived, wrapped, and stored prior to entering DS, this wrapped key may be read, unwrapped, and used to rebuild the metadata and ARC.

In some cases, the hardware may be placed in a certain state for this reading and writing. For example, in some cases, the hardware may be configured to disable (e.g., mask) authentication errors during the rebuild process.

An HMAC may be generated based on the data read. As indicated at 602, this HMAC may be compared against the previously stored HMAC 504 in a second step (Step 2). As indicated in FIG. 4, the boot procedure may proceed if the comparison results in a match (and the hardware may be put in a state to enable authentication errors now that the ARC tree is fully built). Otherwise, the quick boot may be halted (e.g., and an error declared).

As illustrated, in a third step (Step 3) in FIG. 6 (and shown at 408 in FIG. 4), the counter value in the global variable (PIMEM) may be verified by comparison against the value saved in location 502 of RPMB storage. If this is verified, the counter value may be incremented and updated in the RPMB, as well as in the global variable inside TZ PIMEM memory, for the next DS-QB iteration.

Aspects of the present disclosure may help mitigate against various attack paths. For example, as described with reference to FIGS. 5 and 6, generating an HMAC while going into the DS, based on full PIMEM region, storing the HMAC in DDR and comparing that stored HMAC to an HMAC again computed in the QB path can help detect if there is any modification of the data during the DS.

Further, storing a global counter is stored in the PIMEM and RPMB, which is incremented on every LPM cycle can help defend against PIMEM region replay attacks during DS and QB. As noted at 408 in FIG. 4, at the end of every LPM cycle, this value may read from the PIMEM and compared against the stored valued in RPMB. If an attacker replayed the previous copy of the region, then this counter from PIMEM would be the old value and will mismatch against the latest value stored in RPMB. Thus, the counter comparison will fail and appropriate action may be taken.

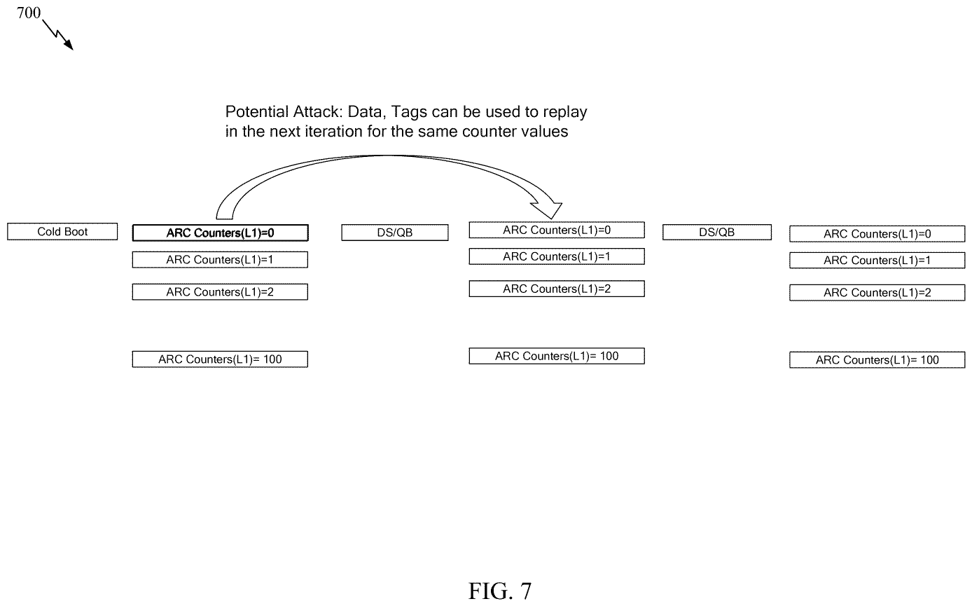

As illustrated in diagram 700 of FIG. 7, in some cases, because Level L1 counters reset after every DS/QB cycle, an attacker could try and use previous DATA/TAG/ARC values to mount a replay attack. As noted above, however, an authentication key (used to generate the TAGs) may be changed every DS/QB cycle. Updating the authentication key in this manner should help mitigate this type of attack, since the hash TAG data generated for the data using an older key would cause authentication to fail.

### Example Method

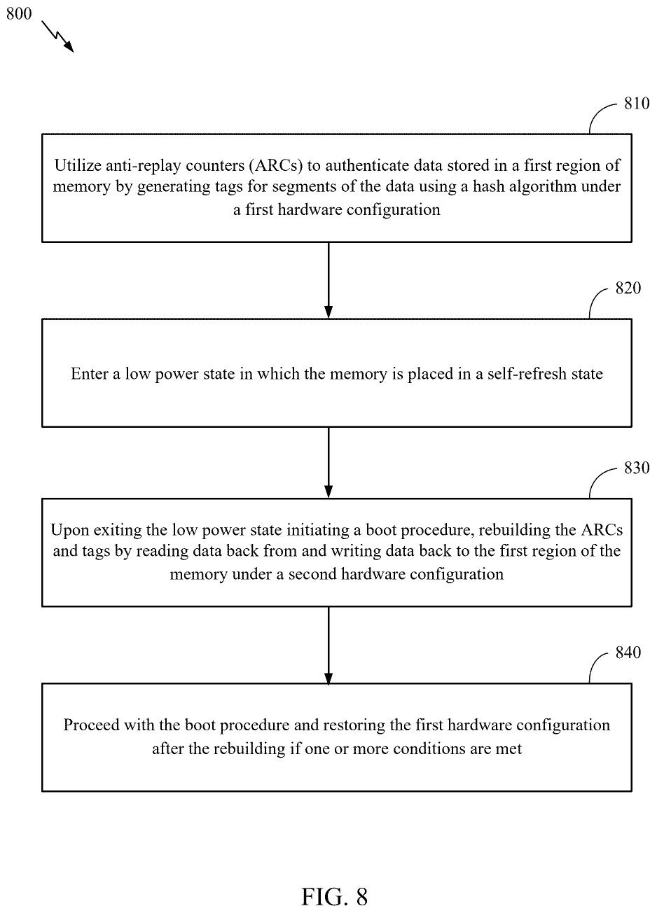

FIG. 8 shows an example of a method 800 for implementing an anti-replay feature for systems supporting an SoC power down while memory (e.g., external DDR) is retained (e.g., via self-refresh). The method 800 may be performed, for example, by one or more devices of an SoC (e.g., CPU 104a of SoC 100 of FIG. 1).

Method 800 begins, at 805, with utilizing anti-replay counters (ARCs) to authenticate data stored in a first region of memory by generating tags for segments of the data using a hash algorithm under a first hardware configuration.

Method 800 then proceeds, to 810, with entering a low power state in which the memory is placed in a self-refresh state.

Method 800 then proceeds, to 815, with rebuilding the ARCs and tags by reading data back from and writing data back to the first region of the memory under a second hardware configuration, upon exiting the low power state initiating a boot procedure.

Method 800 then proceeds, to 820, with proceeding with the boot procedure and restoring the first hardware configuration after the rebuilding if one or more conditions are met.

The various operations of methods described above may be performed by any suitable means capable of performing the corresponding functions. The means may include various hardware and/or software component(s) and/or module(s), including, but not limited to a circuit, an application specific integrated circuit (ASIC), or a processor.

### Example Clauses

Implementation examples are described in the following numbered clauses:
Clause 1: A method, comprising: utilizing anti-replay counters (ARCs) to authenticate data stored in a first region of memory by generating tags for segments of the data using a hash algorithm under a first hardware configuration; entering a low power state in which the memory is placed in a self-refresh state; upon exiting the low power state initiating a boot procedure, rebuilding the ARCs and tags by reading data back from and writing data back to the first region of the memory under a second hardware configuration; and proceeding with the boot procedure and restoring the first hardware configuration after the rebuilding if one or more conditions are met.
Clause 2: The method of Clause 1, further comprising: generating a first authentication code based on data read from the first region prior to entering the low power state; writing the first authentication code to a second region of memory; and generating a second authentication code based on the data read back during the rebuilding.
Clause 3: The method of Clause 2, wherein one of the conditions is considered met if the second authentication code matches the first authentication code.
Clause 4: The method of any one of Clauses 1-3, wherein data stored in the first region of memory is protected via hardware that provides encryption and authentication services.
Clause 5: The method of Clause 4, further comprising: updating, each cycle of entering and exiting the low power state, a counter value stored in a replay protected memory block (RPMB) and a counter value stored in the memory; and upon exiting the low power state, comparing a counter value read from the memory to the counter value stored in RPMB.
Clause 6: The method of Clause 5, wherein one of the conditions is considered met if the counter value read from the memory matches the counter value stored in RPMB.
Clause 7: The method of Clause 6, further comprising aborting the boot procedure if the counter value read from the memory does not match the counter value stored in RPMB.
Clause 8: The method of Clause 4, further comprising: updating, each cycle of entering and exiting the low power state, an authentication key used to generate the tags.
Clause 9: The method of Clause 8, further comprising storing a wrapped copy of the updated authentication key in the memory.
Clause 10: The method of Clause 9, further comprising: upon exiting the low power state, reading the wrapped copy of the updated authentication key from the memory; unwrapping the updated authentication key; and programming the hardware with the updated authentication key.
Clause 11: An apparatus, comprising: at least one memory comprising executable instructions; and at least one processor configured to execute the executable instructions and cause the apparatus to perform a method in accordance with any combination of Clauses 1-10.
Clause 12: An apparatus, comprising means for performing a method in accordance with any combination of Clauses 1-10.
Clause 13: A non-transitory computer-readable medium comprising executable instructions that, when executed by at least one processor of an apparatus, cause the apparatus to perform a method in accordance with any combination of Clauses 1-10.
Clause 14: A computer program product embodied on a computer-readable storage medium comprising code for performing a method in accordance with any combination of Clauses 1-10.

### Additional Considerations

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B and object B touches object C, then objects A and C may still be considered coupled to one another—even if objects A and C do not directly physically touch each other. For instance, a first object may be coupled to a second object even though the first object is never directly physically in contact with the second object. The terms “circuit” and “circuitry” are used broadly and intended to include both hardware implementations of electrical devices and conductors that, when connected and configured, enable the performance of the functions described in the present disclosure, without limitation as to the type of electronic circuits.

The apparatus and methods described in the detailed description are illustrated in the accompanying drawings by various blocks, modules, components, circuits, steps, processes, algorithms, etc. (collectively referred to as “elements”). These elements may be implemented using hardware, for example.

One or more of the components, steps, features, and/or functions illustrated herein may be rearranged and/or combined into a single component, step, feature, or function or embodied in several components, steps, or functions. Additional elements, components, steps, and/or functions may also be added without departing from features disclosed herein. The apparatus, devices, and/or components illustrated herein may be configured to perform one or more of the methods, features, or steps described herein.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover at least: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

It is to be understood that the claims are not limited to the precise configuration and components illustrated above. Various modifications, changes, and variations may be made in the arrangement, operation, and details of the methods and apparatus described above without departing from the scope of the claims.

1. A method, comprising:
utilizing anti-replay counters (ARCs) to authenticate data stored in a first region of memory by generating tags for segments of the data using a hash algorithm under a first hardware configuration;
entering a low power state in which the memory is placed in a self-refresh state;
upon exiting the low power state initiating a boot procedure, rebuilding the ARCs and tags by reading data back from and writing data back to the first region of the memory under a second hardware configuration; and
proceeding with the boot procedure and restoring the first hardware configuration after the rebuilding if one or more conditions are met.

2. The method of claim 1, further comprising:
generating a first authentication code based on data read from the first region prior to entering the low power state;
writing the first authentication code to a second region of memory; and
generating a second authentication code based on the data read back during the rebuilding.

3. The method of claim 2, wherein one of the conditions is considered met if the second authentication code matches the first authentication code.

4. The method of claim 1, wherein data stored in the first region of memory is protected via hardware that provides encryption and authentication services.

5. The method of claim 4, further comprising:
updating, each cycle of entering and exiting the low power state, a counter value stored in a replay protected memory block (RPMB) and a counter value stored in the memory; and
upon exiting the low power state, comparing a counter value read from the memory to the counter value stored in RPMB.

6. The method of claim 5, wherein one of the conditions is considered met if the counter value read from the memory matches the counter value stored in RPMB.

7. The method of claim 6, further comprising aborting the boot procedure if the counter value read from the memory does not match the counter value stored in RPMB.

8. The method of claim 4, further comprising:
updating, each cycle of entering and exiting the low power state, an authentication key used to generate the tags.

9. The method of claim 8, further comprising storing a wrapped copy of the updated authentication key in the memory.

10. The method of claim 9, further comprising:
upon exiting the low power state, reading the wrapped copy of the updated authentication key from the memory;
unwrapping the updated authentication key; and
programming the hardware with the updated authentication key.

11. An apparatus, comprising:
circuitry for utilizing anti-replay counters (ARCs) to authenticate data stored in a first region of memory by generating tags for segments of the data using a hash algorithm under a first hardware configuration;
circuitry for entering a low power state in which the memory is placed in a self-refresh state;
circuitry for, upon exiting the low power state initiating a boot procedure, rebuilding the ARCs and tags by reading data back from and writing data back to the first region of the memory under a second hardware configuration; and
circuitry for proceeding with the boot procedure and restoring the first hardware configuration after the rebuilding if one or more conditions are met.

12. The apparatus of claim 11, further comprising:
circuitry for generating a first authentication code based on data read from the first region prior to entering the low power state;
circuitry for writing the first authentication code to a second region of memory; and
circuitry for generating a second authentication code based on the data read back during the rebuilding.

13. The apparatus of claim 12, wherein one of the conditions is considered met if the second authentication code matches the first authentication code.

14. The apparatus of claim 11, wherein data stored in the first region of memory is protected via hardware that provides encryption and authentication services.

15. The apparatus of claim 14, further comprising:
circuitry for updating, each cycle of entering and exiting the low power state, a counter value stored in a replay protected memory block (RPMB) and a counter value stored in the memory; and
circuitry for upon exiting the low power state, comparing a counter value read from the memory to the counter value stored in RPMB.

16. The apparatus of claim 15, wherein one of the conditions is considered met if the counter value read from the memory matches the counter value stored in RPMB.

17. The apparatus of claim 16, further comprising circuitry for aborting the boot procedure if the counter value read from the memory does not match the counter value stored in RPMB.

18. The apparatus of claim 14, further comprising:
circuitry for updating, each cycle of entering and exiting the low power state, an authentication key used to generate the tags.

19. The apparatus of claim 18, further comprising circuitry for storing a wrapped copy of the updated authentication key in the memory.

20. An apparatus, comprising:
means for utilizing anti-replay counters (ARCs) to authenticate data stored in a first region of memory by generating tags for segments of the data using a hash algorithm under a first hardware configuration;
means for entering a low power state in which the memory is placed in a self-refresh state;
means for, upon exiting the low power state initiating a boot procedure, rebuilding the ARCs and tags by reading data back from and writing data back to the first region of the memory under a second hardware configuration; and
means for proceeding with the boot procedure and restoring the first hardware configuration after the rebuilding if one or more conditions are met.
